(19) United States
(12) Patent Application Publication
(10) Pub. No.: US 2003/0111450 A1
(43) Pub. Date: Jun. 19, 2003

(54) Arc welding apparatus and control method thereof

(75) Inventor: Sung-Jin Hong, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon City (KR)

(21) Appl. No.: 10/198,122

(22) Filed: Jul. 19, 2002

(30) Foreign Application Priority Data
Dec. 14, 2001 (KR) 2001-79512

(51) Int. Cl. B23K 9/10

(52) U.S. Cl. 219/124.34; 219/130.5; 901/42

(57) ABSTRACT

An arc welding apparatus and control method thereof, changes welding power in real time to achieve favorable welding quality. The welding apparatus includes a robot mechanism such as a welding robot, a welding unit including a welding torch at an articulated portion of the robot mechanism, and a control unit to set a welding profile in accordance with welding conditions and a welding path, and to control the robot mechanism and the welding unit in real time in accordance with the welding profile. The method includes setting a welding condition for a parent metal, setting a welding path on the parent metal, setting a welding profile and change factor in accordance with the welding condition and the welding path, and performing a welding operation in accordance with the welding profile. Therefore, the arc welding apparatus and control method thereof achieves a favorable welding result regardless of a type of parent metal by controlling welding power in real time according to conditions of the parent metal.

### CROSS REFERENCE TO RELATED APPLICATIONS

This application claims the benefit of Korean Application No. 2001-79512, filed Dec. 14, 2001, in the Korean Intellectual Property Office, the disclosure of which is incorporated herein by reference.

### BACKGROUND OF THE INVENTION

1. Field of the Invention

The present invention relates to an arc welding apparatus, and more particularly, to an arc welding apparatus and control method thereof to achieve favorable welding quality by changing welding power in real time depending on welding conditions.

2. Description of the Prior Art

Presently, many types of industrial robots are used like, for example, a welding robot to perform welding operations for various welding materials such as iron sheets. In a welding operation that uses a robot, a parent metal is transferred to a jig where the parent metal is held therein. A start point and an end point of a welding line on the parent metal are inputted into the robot, and a welding torch is driven to perform a welding operation via a control unit in accordance with a predetermined program stored therein.

In a welding operation for such a parent metal, an arc welding process is predominantly used. The arc welding process is designed to generate strong current between a welding torch and a parent metal while feeding a wire to the welding torch to instantaneously melt the wire and the parent metal, thereby achieving a fusion bond therebetween. To perform the welding operation, predetermined welding parameters suitable for a particular type of parent metal, and a fusing contact shape between parent metals to be welded, are set and inputted into a robot in advance. Such welding parameters include a welding current, a welding voltage, a distance between a welding torch and a parent metal, a feeding speed of a wire, and a speed of weaving motion of a welding torch. The term “weaving motion” denotes a motion in which a welding robot moves along a simple linear/curvilinear welding path while oscillating from side to side to increase welding penetration with one pass along the path.

FIG. 1 is a graph illustrating variation of current supply of a conventional arc welding apparatus. As shown in FIG. 1, base current “A1” is supplied during a time period “T1” from a starting point of the welding process. After elapse of the time period “T1”, the base current “A1” is stepwise increased to a maximum current “A2” in a time section “T2”. After the base current “A1” is increased to the maximum current “A2”, a main welding procedure is performed while being supplied with the maximum current “A2” during a predetermined time period “T3”. After the elapse of the time period “T3”, the maximum current “A2” is stepwise decreased to a finishing current “A3” in a time period “T4”. The finishing current “A3” is lower than the maximum current “A2” but higher than the base current “A1”. With supply of the finishing current “A3” during a time period “T5”, the welding operation is completed. In the welding process, the base current “A1” and the finishing current “A3” generate arcs smoothly at the starting and finishing points of the welding operation.

As mentioned above, a conventional welding robot performs a welding operation with a base current, a maximum current and a finishing current previously determined according to types of a parent metal to be welded. Where an object material has a tapered shape (that is, an object material is thin), an internal temperature of the object material is rapidly increased, thereby inducing damage of the parent metal. Therefore, since an output current is not controlled in real time according to welding conditions, deterioration of welding quality such as damage of a parent metal occurs.

### SUMMARY OF THE INVENTION

Accordingly, it is an object of the present invention to provide an arc welding apparatus and control method thereof to achieve favorable welding quality by changing welding power in real time depending on welding conditions.

Additional objects and advantages of the invention will be set forth in part in the description which follows and, in part, will be obvious from the description, or may be learned by practice of the invention.

The foregoing and other objects of the present invention are achieved by providing an arc welding apparatus including a robot mechanism such as a welding robot, a welding unit including a welding torch at an articulated portion of the robot mechanism, and a control unit to set a welding profile in accordance with welding conditions and a welding path, and to control the robot mechanism and the welding unit in real time according to the welding profile.

The foregoing and other objects of the present invention are achieved by providing a method to control an arc welding apparatus including setting a welding condition for a parent metal, setting a welding path on the parent metal, setting a welding profile and change factor in accordance with the welding condition and the welding path, and performing a welding operation in accordance with the welding profile.

### BRIEF DESCRIPTION OF THE DRAWINGS

These and other objects and advantages of the invention will become apparent and more appreciated from the following description of the preferred embodiments, taken in conjunction with the accompanying drawings of which:

FIG. 1 is a graph illustrating variation of current supply of a conventional arc welding apparatus;

FIG. 2 is a block diagram of an arc welding apparatus according to an embodiment of the present invention;

FIG. 3 is a flow chart illustrating a control method of the arc welding apparatus as described in FIG. 2;

FIGS. 4A through 4C are flow charts illustrating control methods of the arc welding apparatus as described in FIG. 2; and

FIGS. 5A through 5E is a graph illustrating an operation of the arc welding apparatus as described in FIG. 2.

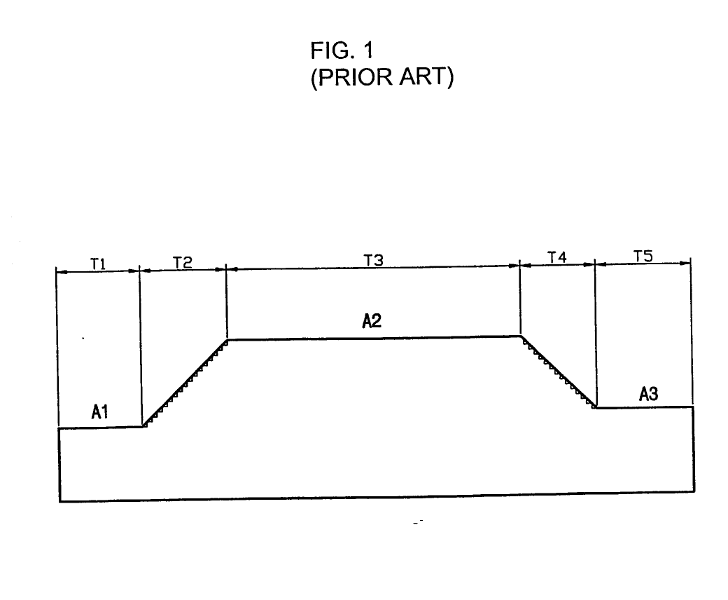

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

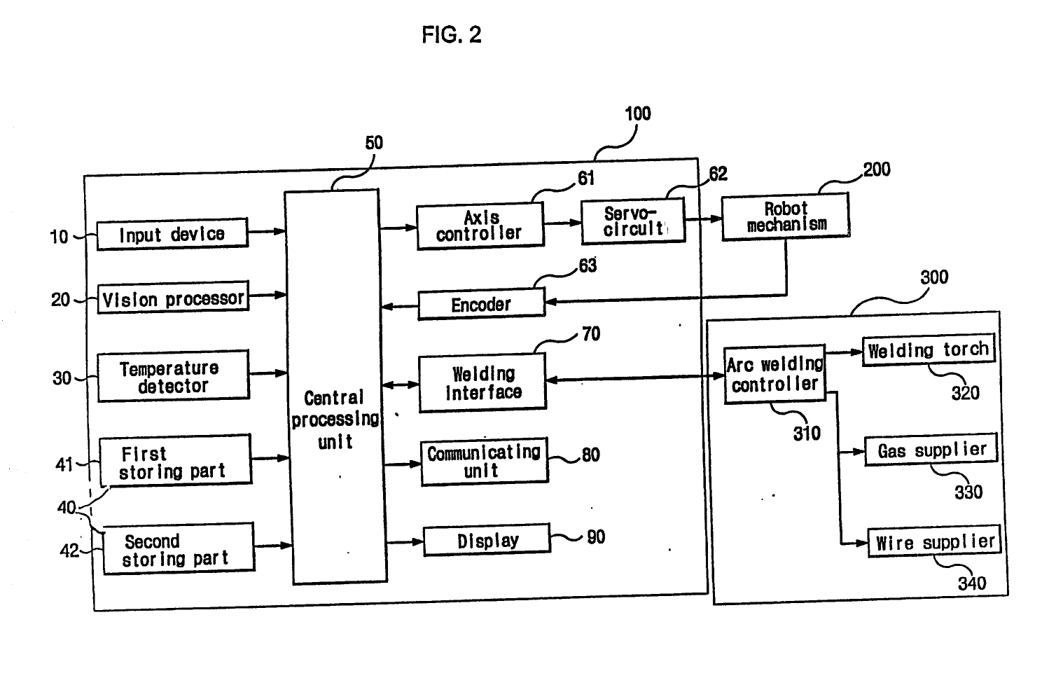

FIG. 2 is a block diagram of an arc welding apparatus according to an embodiment of the present invention. As shown in FIG. 2, the arc welding apparatus includes a robot mechanism 200 (i.e., a welding robot), a welding unit 300 including a welding torch 320 at an articulated portion of the robot mechanism 200, a gas supplier 330, a wire supplier 340, and an arc welding controller 310 to control the welding torch 320, the gas supplier 330 and the wire supplier 340. The arc welding apparatus also includes a control unit 100 to control the robot mechanism 200 and the welding unit 300.

The control unit 100 includes a central processing unit 50 to control the entire operation of the arc welding apparatus. The central processing unit 50 is connected to an input device 10 having various input buttons to permit operation commands from an operator and data to be inputted into the central processing unit 50. In addition, the central processing unit 50 is connected to a vision processor 20 having a laser vision to calculate a welding path on a welding parent metal, and is connected to a temperature detector 30 to detect a temperature of the parent metal. The temperature sensor 30 detects the temperature of the parent metal by contact or non-contact, and sends the detected temperature to the central processing unit 50.

The control unit 100 includes a storing unit 40 to store data and programs, an axis controller 61 to control a robot, a welding interface 70 connected to the arc welding controller 310 of the welding unit 300, a communicating unit 80 to communicate with external devices, and a display 90 to display operation information. All of the components included in the control unit 100 are connected to the central processing unit 50 via a bus. The control unit 100 also includes a servo-circuit 62 connected to the axis controller 61 to control a servo-motor (not shown) to drive individual axes of the robot mechanism 200.

The storing unit 40 includes a first storing part 41 to store a control program, and a second storing part 42 to store data and control parameters. The display 90 includes a CRT or an LCD to display an operational state of the robot mechanism 200. The axis controller 61 includes an interpolator (not shown) to control a plurality of axes. The robot mechanism 200 includes a plurality of sensors (encoders not shown) at individual rotating positions of the robot mechanism 200. Data detected by the sensors are sent to the central processing unit 50 through an encoder 63, and the central processing unit 50 stores the received data into the second storing part 42. The communicating unit 80 is connected to external devices to receive programs, data commands and operational commands. The communication unit includes a serial communication unit, parallel communication unit, field bus communication unit and local area network (LAN) unit.

An arc welding process is described below.

First, a desired parent metal is held in a welding jig. The central processing unit 50 performs a welding operation in accordance with previously stored data. Prior to initiation of the welding operation, a welding start point, a welding end point and a welding line of a welding area are verified. Thus, error in the welding start point, welding end point, and welding line is compensated for based on a real location of the parent metal.

A method to calculate and verify the welding start point, welding end point and welding line of a welding area is well known. For example, there is a method in which a shape of a contacting area between parent metals with respect to a welding line, an approximate welding start point and welding end point are predetermined. The welding torch 320 is disposed at a spatial position adjacent to the welding start point and is moved to the parent metals. Contact between the welding torch and the parent metals is detected to determine a position of the parent metals. The welding line is then calculated on the basis of the determined position of the parent metals and the shape of the contacting area between the parent metals, thereby performing the welding operation along the welding line.

When the welding torch 320 is positioned at the welding start point, a wire is sufficiently fed from the wire supplier 340 while shielding gas is fed from the gas supplier 330 to perform a welding operation on a parent metal.

A control method for the arc welding apparatus is described below.

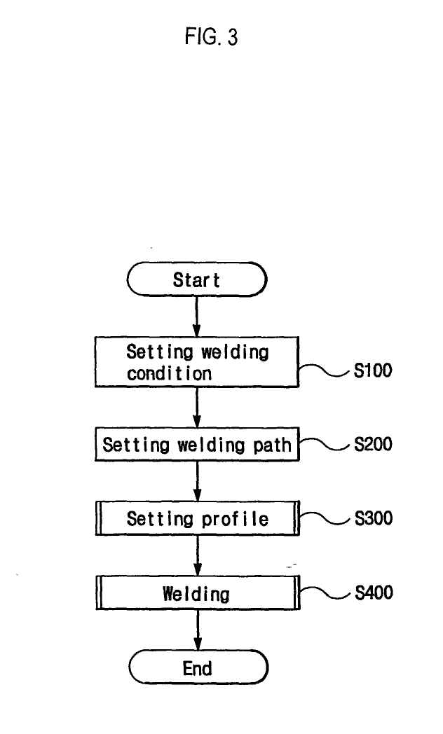

FIG. 3 is a flow chart illustrating a control method of the arc welding apparatus as described in FIG. 2. As shown in FIG. 3, the central processing unit 50 determines desired welding parameters (S100). A welding condition includes values related to a kind of parent metal, a welding voltage, an electrical current, etc. Data of the welding condition is inputted through the input device 10 or the communicating unit 80, and the central processing unit 50 stores the inputted data into the second storing part 42.

After determining the welding condition at operation (S100), the central processing unit 50 determines a weld path through the vision processor 20 (S200). The vision processor 20 calculates the welding path with a laser vision and then sends the welding path to the central processing unit 50. As described above, the central processing unit 50 determines the welding path, and stores data relevant to the determined welding path into the second storing part 42. The central processing unit 50 sets up a welding profile (S300) on the basis of the welding condition determined at operation S100 and the data determined at operation S200, thereby allowing a welding operation to be fulfilled in accordance with the welding profile (S400).

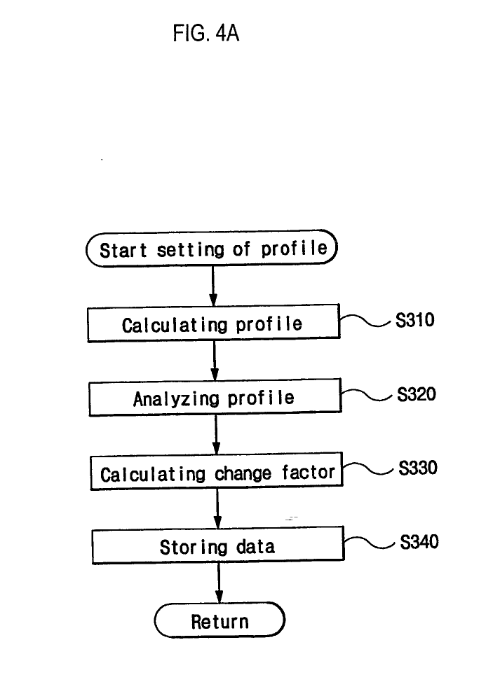

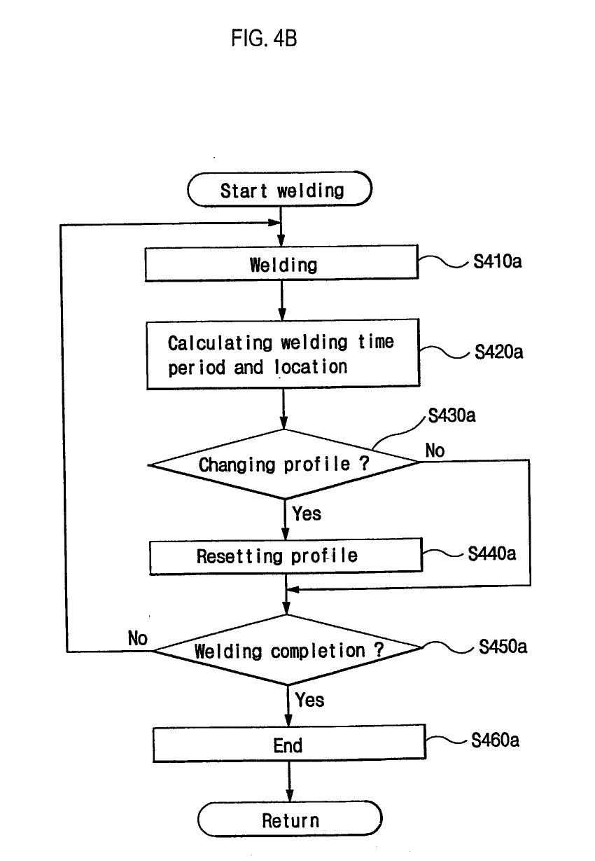

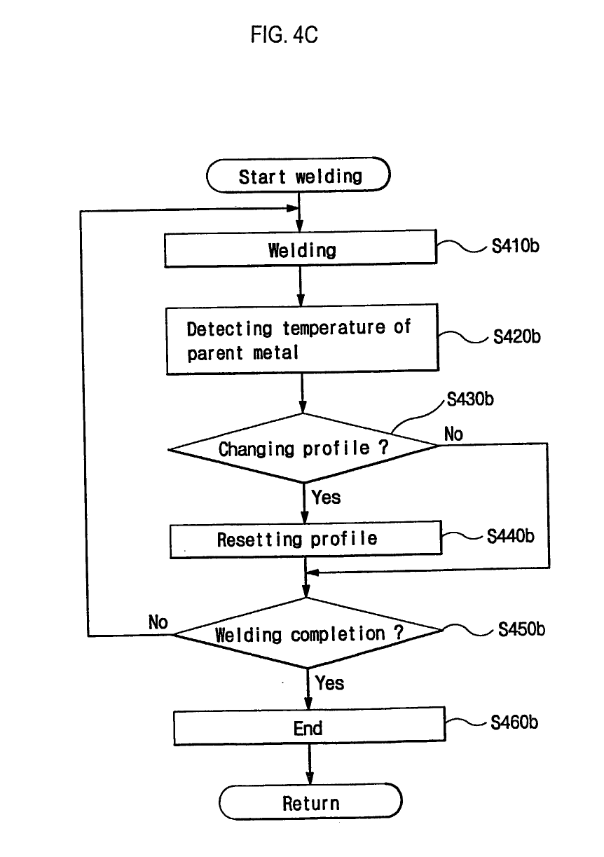

FIG. 4A is a flow chart showing a setup operation of the welding profile at operation S300. As shown in FIG. 4A, data obtained from the welding path determined at operation S200 is loaded from the second storing part 42 by the central processing unit 50, thereby allowing a profile of welding voltage/welding current to be calculated based on the data (S310). The central processing unit 50 performs an analysis of the calculated profile (S320). The central processing unit 50 calculates a change factor in accordance with the analysis result at operation S330. The central processing unit 50 stores the calculated change factor into the second storing part 43 (S340), and then returns to the start of the setup operation.

FIG. 4B is a flow chart showing the welding operation of the welding profile at operation S400. As shown in FIG. 4B, the central processing unit 50 performs a welding operation while controlling the robot mechanism 200 and the welding unit 300 (S410a). First, the central processing unit 50 moves the welding torch 320 to the welding start point by controlling the servo-circuit 62 through the axis controller 61. Here, the encoder 63 processes output signals from sensors installed at individual rotating positions of the robot mechanism 200, and sends the output signals to the central processing unit 50. Therefore, the central processing unit 50 realizes a present location of the robot mechanism 200, and thus precisely positions the welding torch 320 on the welding start point by controlling the servo-circuit 62 through the axis controller 61.

When the welding torch 320 is positioned on the welding start point, the central processing unit 50 sends data (i.e., according to a welding profile) to the welding unit 300 via the welding interface 70. The arc welding controller 310 controls the gas supplier 330 to enable gas to be supplied from the gas supplier 330, and after an elapse of a predetermined time period (ΔT), allows electrical power to be applied to the welding torch 320. The wire supplier 340 supplies wire to replenish the wire consumed as a result of performing the welding operation. Accordingly, the central processing unit 50 controls the robot mechanism 200 to perform the welding operation so that the welding torch 320 is moved along the welding path at a predetermined speed.

As the welding operation proceeds in the above-described way, the central processing unit 50 calculates a time period required for the welding operation, and determines a present welding location by a received output signal from the encoder 63 (S420a). Thereafter, the central processing unit 50 determines whether or not the welding profile needs to be changed, based on the results of the received output signal (S430a). At operation S430a, the central processing unit 50 determines whether or not the present welding location determined by the output signal from the encoder 63 is a changed location for the welding profile to confirm whether or not the welding profile has changed. At operation S430a, if the present welding location is a changed location for the welding profile, the central processing unit 50 again sets up the welding profile by loading associated data stored in the second storing part 42 (S440a). However, at operation S430a, the central processing unit 50 may determine that the welding profile has changed by determining a welding time instead of determining a present welding location obtained by the output signal from the encoder 63.

The central processing unit 50 determines whether or not the welding operation is completed (S450a). At operation S450a, if the welding operation is completed, the central processing unit 50 sends a signal for completing the welding operation to the arc welding controller 310. Subsequently, the arc welding controller 310 interrupts power applied to the welding torch 320, and after an elapse of a predetermined time period (ΔT), controls the gas supplier 330 to stop supply of gas and complete the welding operation (S460a).

FIG. 4C is a flow chart showing another example of the welding operation (S400). As shown in FIG. 4C, the central processing unit 50 performs a welding operation while controlling the robot mechanism 200 and the welding unit 300. First, the central processing unit 50 moves the welding torch 320 to the welding start point by controlling the servo-circuit 62 through the axis controller 61. Here, the encoder 63 processes output signals from sensors installed at individual rotating positions of the robot mechanism 200, and sends the output signals to the central processing unit 50. Therefore, the central processing unit 50 realizes a present location of the robot mechanism 200, and thus precisely locates the welding torch 320 on the welding start point by controlling the servo-circuit 62 through the axis controller 61.

When the welding torch 320 is positioned on the welding start point, the central processing unit 50 sends data (i.e., according to a welding profile) to the welding unit 300 via the welding interface 70. The arc welding controller 310 controls the gas supplier 330 to enable gas to be supplied from the gas supplier 330, and after an elapse of a predetermined time period (ΔT), allows electrical power to be applied to the welding torch 320. Then, the wire supplier 340 supplies a wire to replenish a wire consumed as a result of performing the welding operation. Accordingly, the central processing unit controls the robot mechanism 200 to perform a welding operation so that the welding torch 320 is moved along the welding path at a predetermined speed.

As the welding operation proceeds in the above-described way, the central processing unit 50 detects temperature of a parent metal (S420b). Thereafter, the central processing unit 50 determines whether or not the welding profile needs to be changed, based on the detected temperature of the parent metal (S430b). If the temperature of the parent metal detected at operation S430b is a changed temperature for the welding profile, the central processing unit 50 again sets up the welding profile by loading associated data stored in the second storing part 42 (S440b).

The central processing unit 50 determines whether or not the welding operation is completed (S450b). At operation S450b, if the welding operation is completed, the central processing unit 50 sends a signal for completing the welding operation to the arc welding controller 310 through the welding interface 70. Subsequently, the arc welding controller 310 interrupts power applied to the welding torch 320, and after an elapse of a predetermined time period (ΔT), controls the gas supplier 330 to stop supply of gas and complete the welding operation (S460b).

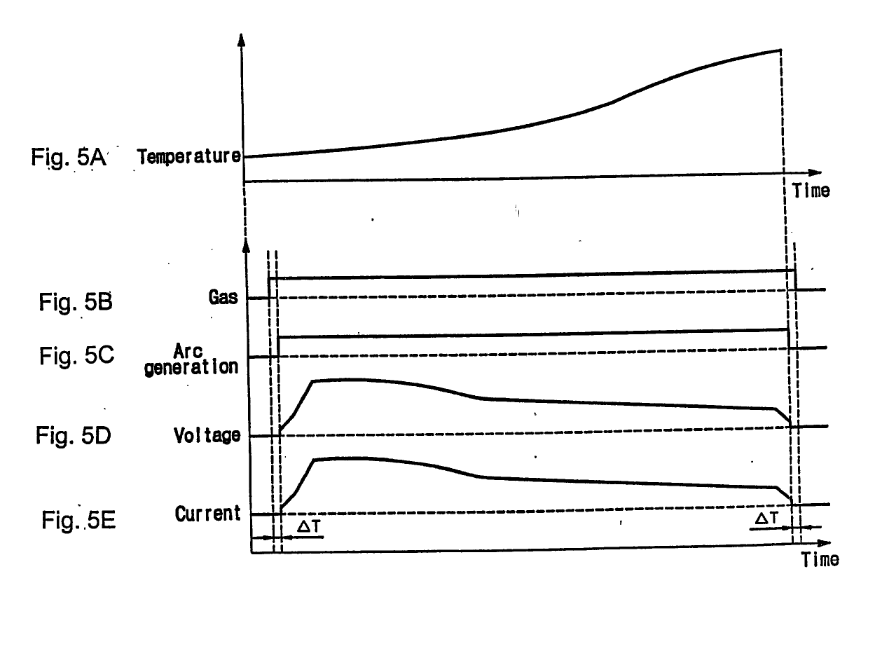

FIGS. 5A through 5E are graphs illustrating the welding operation of the arc welding apparatus shown in FIG. 2. A welding profile is set for voltage (FIG. 5D) and current (FIG. 5E). As a welding operation proceeds in accordance to the welding profile, temperature of a parent metal is increased. Here, a supply of gas is initiated (FIG. 5B), and after an elapse of a predetermined time period (ΔT), electric power (voltage/current) is applied. If the electric power is cut off, and the predetermined time period (ΔT) elapses, the supply of gas is interrupted.

As shown in the graphs, locations at which the electric power (voltage/current) values change indicate changing points of the welding profile. The changing points are detected based on the temperature of a parent metal, a location of a welding torch, or a welding time, thereby changing the electric power.

As described above, the present invention relates to an arc welding apparatus and control method thereof in which a welding condition of a parent metal and a welding path on the parent metal is predetermined. A welding profile and change factors are set based on the welding condition and the welding path so that a welding operation is performed in accordance to the welding profile. Therefore, welding power of an arc welding apparatus is controlled in real time according to conditions and states of the parent metal, thereby enabling favorable results to be obtained regardless of a type of a welding parent metal.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An arc welding apparatus comprising:
a robot mechanism;
a welding unit including a welding torch at a rotating position of the robot mechanism; and
a control unit to set a welding profile in accordance with welding conditions and a welding path, and to control the robot mechanism and the welding unit in real time in accordance with the welding profile.

2. The arc welding apparatus as set forth in claim 1, wherein the welding unit comprises:
a gas supplier;
a wire supplier; and
an arc welding controller to control the gas supplier, wire supplier, and a power applied to the welding torch via the control unit.

3. The arc welding apparatus as set forth in claim 1, wherein the control unit controls the arc welding controller to control power applied to the welding torch in real time.

4. The arc welding apparatus as set forth in claim 1, wherein the control unit comprises:
a central processing unit;
an input device having input buttons to permit operation commands from an operator and data to be inputted into the central processing unit;
a vision processor to calculate the welding path on a parent metal;
an axis controller to control a servo-circuit to drive individual axes of the robot mechanism via control of the central processing unit;
an encoder to detect signals from the robot mechanism and send the signals to the central processing unit; and
a welding interface to connect the central processing unit and the welding unit.

5. The arc welding apparatus as set forth in claim 4, wherein the vision processor comprises a laser vision to calculate the welding path on the parent metal using a laser.

6. The arc welding apparatus as set forth in claim 4, wherein the control unit comprises a contact type temperature sensor or a non-contact type temperature sensor to detect temperature of the parent metal.

7. The arc welding apparatus as set forth in claim 4, wherein the control unit comprises:
a communicating unit to allow communication of the central processing unit with external devices;
a display unit to display operation information;
a first storing part to store a control program of the arc welding apparatus; and
a second storing part to store data and control parameters.

8. The arc welding apparatus as set forth in claim 7, wherein the communicating unit is connected to the external devices to receive programs, data and operational commands, and is selected from the group consisting of wireless communication, serial communication, parallel communication, field bus communication and local area network (LAN).

9. A method to control an arc welding apparatus comprising:
setting a welding condition for a parent metal;
setting a welding path on the parent metal;
setting a welding profile and change factor in accordance with the welding condition and the welding path; and
performing a welding operation in accordance with the welding profile.

10. The method to control an arc welding apparatus as set forth in claim 9, wherein the setting of the welding condition is previously set according to the parent metal, and comprises welding parameters including a welding voltage and an electric current to set the welding profile of the parent metal.

11. The method to control an arc welding apparatus as set forth in claim 9, wherein the setting of the welding path comprises:
calculating a variation of a thickness of the parent metal.

12. The method to control an arc welding apparatus as set forth in claim 9, wherein the setting of the welding profile comprises:
calculating the welding profile to control a welding power according to the welding condition and the welding path; and
calculating the change factor based on the calculated welding profile to control the welding power.

13. The method to control an arc welding apparatus as set forth in claim 9, wherein the performing of the welding operation comprises:
performing the welding operation according to the welding profile;
determining whether a present location is a changed location of the welding profile according to the change factor;
resetting the welding profile if the present location of the welding profile has changed;
determining whether the present location is a location to complete the welding operation; and
shutting off a welding power, and after an elapse of a predetermined time period, shutting off gas to complete the welding operation if the present location is the location to complete the welding operation.

14. The method to control an arc welding apparatus as set forth in claim 9, wherein the performing of the welding operation comprises:
performing the welding operation according to the welding profile;
detecting a temperature of the parent metal;
determining whether the detected temperature is a changed temperature of the welding profile according to the change factor;
resetting the welding profile if the detected temperature of the welding profile has changed;
determining whether the present location is a location to complete the welding operation; and
shutting off a welding power, and after an elapse of a predetermined time period, shutting off gas to complete the welding operation if the present location is the location to complete the welding operation.

15. The method to control an arc welding apparatus as set forth in claim 9, wherein the performing of the welding operation comprises:
performing the welding operation according to the welding profile;
determining whether a welding time of the welding profile has changed according to the change factor;
resetting the welding profile if the welding time of the welding profile has changed;
determining whether the welding time is a time to complete the welding operation; and
shutting off a welding power, and gas to complete the welding operation if the welding time is a time to complete the welding operation.

16. An arc welding apparatus for welding a parent metal, comprising:
a robot mechanism;
a welding unit including a welding torch at a rotating position of the robot mechanism;
a control unit to set a predetermined welding condition and welding path on the parent metal, set a welding profile and at least one change factor based upon the welding condition and the welding path, and control the robot mechanism and the welding unit in accordance with the welding profile and the at least one change factor.

17. The arc welding apparatus as set forth in claim 16, wherein the at least one change factor comprises a time period for the welding operation and a present welding location of the welding unit.

18. The arc welding apparatus as set forth in claim 17, wherein the control unit compares the time period and the present welding location with the welding profile and changes the welding profile according to the comparison.

19. The arc welding apparatus as set forth in claim 16, wherein the at least one change factor comprises a temperature of the parent metal.

20. The arc welding apparatus as set forth in claim 19, further comprising:
temperature sensors to determine a temperature of the parent metal, wherein the control unit compares the temperature of the parent metal with the welding profile and changes the welding profile according to the comparison.

21. A method to control an arc welding apparatus for welding a parent metal, comprising:
determining a welding profile for a welding operation of the parent metal;
determining states of the parent metal while performing the welding operation; and
controlling a welding power while performing the welding operation based upon the determined states.

22. An arc welding apparatus for welding a parent metal, comprising:
a robot mechanism;
a welding unit including a welding torch at a rotating position of the robot mechanism; and
a control unit to set a welding profile in accordance with a predetermined welding condition for the parent metal, detect a change in the welding profile based on the predetermined welding condition, and control the robot mechanism and the welding unit in real time in accordance with the change in the welding profile to perform a welding operation.

23. The arc welding apparatus as set forth in claim 22, wherein a change factor is used to detect the change in the welding profile.

24. The arc welding apparatus as set forth in claim 23, wherein the change factor is based on a change in temperature of the parent metal, a present location of the welding unit, or time.

25. The arc welding apparatus as set forth in claim 23, further comprising:
a determining unit to determine whether the present location is a changed location of the welding profile according to the change factor; and
a resetting unit to reset the welding profile if the present location relative to the welding profile has changed.

26. The arc welding apparatus as set forth in claim 23, further comprising:
a determining unit to determine whether the temperature is a changed temperature of the welding profile according to the change factor; and
a resetting unit to reset the welding profile if the temperature relative to the welding profile has changed.
